(19) United States
(12) Patent Application Publication
(10) Pub. No.: US 2007/0173214 A1
(43) Pub. Date: Jul. 26, 2007

(54) WIRELESS AUTONOMOUS DEVICE SYSTEM

(75) Inventors: Marlin H. Mickle, Pittsburgh, PA (US); Minhong Mi, Sewickley, PA (US); David W. Sammel JR., Pittsburgh, PA (US); James T. Cain, Pittsburgh, PA (US); Leonid Mats, Pittsburgh, PA (US)

Correspondence Address: ECKERT SEAMANS CHERIN & MELLOTT, 600 GRANT STREET, 44TH FLOOR, PITTSBURGH, PA, 15219, US

(73) Assignee: University of Pittsburgh-Of the Commonwealth System of Higher Education, Pittsburgh, PA (US)

(21) Appl. No.: 11/619,770

(22) Filed: Jan. 4, 2007

Related U.S. Application Data
(60) Provisional application No. 60/756,308, filed on Jan. 5, 2006.

(51) Int. Cl. H04B 1/04; H02M 5/06

(52) U.S. Cl. 455/127.1; 363/170

(57) ABSTRACT

A method of powering a wireless autonomous device having energy harvesting circuitry, on-board electronic circuitry, and RF transmitter circuitry using an RF transmitting profile that includes a plurality of RF pulses. That same profile may also be used to simultaneously communicate information to the wireless autonomous device in a number of ways, including different encoding schemes. A system including a plurality of wireless autonomous devices that employs the methods is also provided. Further, a method of designing a wireless autonomous device system and/or a wireless autonomous device to be used therein is provided that employs an equivalent circuit for the wireless autonomous device that is in the form of a lumped parameter RLC circuit with an energy source.

### CROSS-REFERENCE TO RELATED APPLICATION

This application claims the benefit of U.S. Provisional Application No. 60/756,308, entitled “AM Energy Harvesting Transmitting Profile(s),” which was filed on Jan. 5, 2006, the disclosure of which is incorporated herein by reference.

### GOVERNMENT CONTRACT

This work was supported in part by a grant from NASA under Contract No. NNK04OA29C. The United States government may have certain rights in the invention described herein.

### FIELD OF THE INVENTION

The present invention relates to the powering of wireless autonomous devices by harvesting RF energy transmitted through the air and converting it to DC energy, and in particular to a wireless autonomous device system that employs a pulsed RF transmitting profile to transmit energy and, in some embodiments, to simultaneously transmit information to wireless autonomous devices. The invention also relates to a method for designing a wireless autonomous device system.

### BACKGROUND OF THE INVENTION

A wireless autonomous device (WAD) is an electronic device that has no on board battery or wired power supply. WADs are powered by receiving radio frequency (RF) energy that is either directed toward them (a directed source) or is ambient and converting the received RF energy into a direct current (DC) voltage. The DC voltage is used to power on-board electronics, such and a microprocessor and/or sensing circuitry, and an RF transmitter which communicates information, such as a sensor reading, to a remote receiver. WADs are employed in a number of fields, such as radio frequency identification (RFID) systems (wherein the WADs are radio frequency tags or transponders), security monitoring and remote sensing, among others. WADs are particularly desirable in certain applications as they have essentially an infinite shelf life and do not require wiring because, as described above, they are powered by RF energy transmitted through the air. Traditionally, the RF energy that is transmitted through the air for powering WADs has been continuous wave RF energy. While such continuous wave systems have proven to be effective for a number of applications, there is room for improvement in the field of wireless autonomous device systems.

### SUMMARY OF THE INVENTION

In one embodiment, the invention provides a method of powering a wireless autonomous device having energy harvesting circuitry, on-board electronic circuitry, and RF transmitter circuitry. The method includes providing the wireless autonomous device, generating an RF transmitting profile that includes a plurality of pulses each having RF energy of a first RF frequency range, wherein each of the pulses is provided during a respective on period of the RF transmitting profile and wherein each adjacent pair of the pulses is separated by a respective off period of the RF transmitting profile, each off period not including any RF energy, and transmitting the RF transmitting profile to the wireless autonomous device. The method further includes receiving the RF transmitting profile in the energy harvesting circuitry, wherein the energy harvesting circuitry generates DC energy from the pulses included in the RF transmitting profile, and using the DC energy to power the on-board electronic circuitry and the RF transmitter circuitry to enable the RF transmitter circuitry to transmit an RF information signal to a receiver device, wherein the RF information signal has a second RF frequency range different than the first RF frequency range.

In one embodiment, in the RF transmitting profile, each of the on periods has a duration τ_{ON} and each of the off periods has a duration τ_{OFF}. In a specific embodiment thereof, an effective average power regulation establishes a regulated maximum power and a regulated average power permitted during a regulation time period, wherein the regulation time period is equal to the sum of the duration τ_{ON} and the duration τ_{OFF}, and wherein a power of each of the pulses is equal to or less than the regulated maximum power and an average power in the RF transmitting profile over each adjacent pair of on periods and off periods is equal to or less than the regulated average power.

The method may further include providing a plurality of other wireless autonomous devices in a wireless autonomous device system, wherein each of the other wireless autonomous devices receives and is powered by the RF transmitting profile and is adapted to transmit a respective other RF information signal to the receiver device. In this embodiment, the RF transmitting profile is used to synchronize the timing of the transmission of the RF information signals to avoid collisions among them. For example, each of the other wireless autonomous devices and the wireless autonomous device may be assigned one of a plurality of unique identification numbers, wherein each device is adapted to transmit its RF information signal to the receiver device when a number of pulses of the RF transmitting profile it receives is equal to the identification number assigned thereto.

In another embodiment, the RF transmitting profile is generated in a manner wherein the RF transmitting profile includes information intended for the wireless autonomous device, the step of transmitting the RF transmitting profile to the wireless autonomous device further includes communicating the information to the wireless autonomous device as part of the RF transmitting profile, and the method further includes obtaining the information from the RF transmitting profile in the wireless autonomous device.

In one particular embodiment, the pulses of the RF transmitting profile include a plurality of synchronizing pulses and a plurality of data pulses, wherein each adjacent pair of the synchronizing pulses is separated by a respective data region. Each data region either: (i) includes one of the data pulses or (ii) no data pulse, and each data region having one of the data pulses represents a first logic value and each data region having no data pulse represents a second logic value. The information to be communicated is then represented by the data regions. In another example, the pulses of the RF transmitting profile may represent a plurality of state changes, wherein the information included in the RF transmitting profile is represented by a plurality of bits of data, each bit of data being signified by at least one of the state changes. Also, each of the pulses of the RF transmitting profile may have a respective width, wherein the information included in the RF transmitting profile is represented by varying the widths. As will be appreciated, other implementations are also possible.

The invention also relates to a wireless autonomous device system that implements the various methods described above.

According to still a further aspect of the invention, a method of designing a wireless autonomous device system having an RF transmitter device and a receiver device is provided. The method includes creating an equivalent circuit for a wireless autonomous device to be used in the wireless autonomous device system, the wireless autonomous device including energy harvesting circuitry, on-board electronic circuitry, and RF transmitter circuitry, the energy harvesting circuitry generating DC energy from RF energy received from the RF transmitter device, the DC energy being used to power the on-board electronic circuitry and the RF transmitter circuitry to enable the RF transmitter circuitry to transmit an RF information signal to the receiver device. The equivalent circuit in this method is in the form of a lumped parameter RLC circuit with an energy source. The method further includes using the equivalent circuit to do one or both of: (i) design one or more selected parameters of the wireless autonomous device system, and (ii) design one or more selected portions of the wireless autonomous device to be used in the wireless autonomous device system.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of an embodiment of a wireless autonomous device that may be employed in the embodiments of the invention as described herein;

FIG. 2 is a particular embodiment of the energy harvesting circuitry of the wireless autonomous device of FIG. 1;

FIG. 3 is a circuit diagram of one particular embodiment of the wireless autonomous device of FIG. 1;

FIG. 4 is a schematic illustration of a wireless autonomous device system according to an embodiment of the invention in which a plurality of wireless autonomous devices, such as in the form of RFID tags, may be employed;

FIG. 5 is a schematic illustration of an RF transmitting profile according to an aspect of the invention that may be used to provide power to a wireless autonomous device as shown in FIG. 1;

FIG. 6 is a schematic illustration of one particular embodiment of a wireless autonomous device system according to an aspect of the invention;

FIG. 7 is a schematic illustration of a pulsed RF transmitting profile that may be employed in the system of FIG. 6;

FIG. 8 is a schematic illustration of a pulsed RF transmitting profile according to a further embodiment of the invention that may be used to provide power to one or more wireless autonomous devices as described herein while simultaneously communicating information to the wireless autonomous devices;

FIGS. 9 and 10 are schematic illustrations of different embodiments of a pulsed RF transmitting profile according to a further embodiment of the invention that may be used to provide power by energy harvesting to one or more wireless autonomous devices as described herein while simultaneously communicating information to the wireless autonomous devices based on the state changes occurring in the RF transmitting profile;

FIG. 11 is a circuit diagram of one example of a lumped parameter RLC circuit with an energy source that represents the wireless autonomous device shown in FIG. 1; and

FIG. 12 is a schematic diagram of the wireless autonomous device system of FIG. 4 which illustrates certain parameters relating to the wireless autonomous device and the wireless autonomous devices to be used therein that are typically considered by a designer when designing the wireless autonomous device system and the wireless autonomous devices.

### DESCRIPTION OF THE PREFERRED EMBODIMENTS

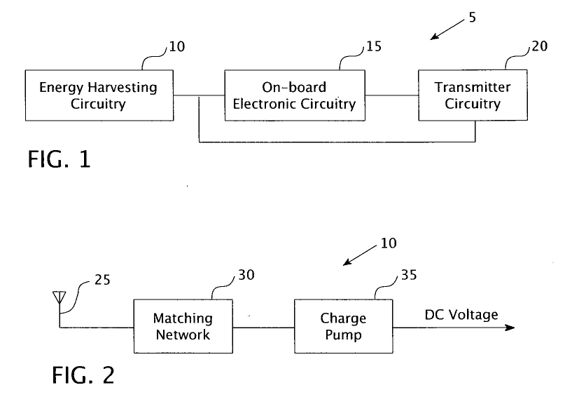

FIG. 1 is a block diagram of an embodiment of a wireless autonomous device (WAD) 5 that may be employed in the embodiments of the invention as described herein. The WAD 5 includes energy harvesting circuitry 10 that is operatively coupled to on-board electronic circuitry 15, which in turn is operatively coupled to transmitter circuitry 20. In operation, the energy harvesting circuitry 10 is structured to receive RF energy of a particular RF frequency range and harvest energy therefrom by converting the received RF energy into DC energy, e.g., a DC voltage. As used herein, the term “RF frequency range” or “frequency range” shall refer to either a single RF frequency or a band of multiple RF frequencies. The DC voltage is then used to power the on-board electronic circuitry 15 and the transmitter circuitry 20. The transmitter circuitry 20 is structured to transmit an RF information signal to a receiving device at a frequency range that is different from the frequency range of the RF energy received by the energy harvesting circuitry 10. The RF information signal may, for example, include data that identifies the WAD 5 and/or data that is sensed by a component provided as part of the on-board electronic circuitry 15.

In a particular embodiment, shown in FIG. 2, the energy harvesting circuitry 10 includes an antenna 25 which is electrically connected to a matching network 30, which in turn is electrically connected to a voltage boosting and rectifying circuit preferably in the form of a one or more stage charge pump 35. Charge pumps are well known in the art. Basically, one stage of a charge pump essentially doubles the effective amplitude of an AC input voltage with the resulting increased DC voltage appearing on an output capacitor. The voltage could be stored using a rechargeable battery. Successive stages of a charge pump, if present, will essentially increase the voltage from the previous stage resulting in an increased output voltage. In operation, the antenna 25 receives RF energy that is transmitted in space by a far-field source, such as an RF source. The RF energy received by the antenna 25 is provided, in the form of an AC signal, to the charge pump 35 through the matching network 30. The charge pump 35 rectifies the received AC signal to produce a DC signal that is amplified as compared to what it would have been had a simple rectifier been used. In one particular embodiment, the matching network 30 is chosen (i.e., its impedance is chosen) so as to maximize the voltage of the DC signal output by charge pump 35. In other words, the matching network 30 matches the impedance of the antenna 25 to the charge pump 35 solely on the basis of maximizing the DC output of the charge pump 35. In the preferred embodiment, the matching network 30 is an LC circuit of either an L topology (which includes one inductor and one capacitor) or a π topology (which includes one inductor and two capacitors) wherein the inductance of the LC circuit and the capacitance of the LC circuit are chosen so as to maximize the DC output of the charge pump 35. In one embodiment, an LC tank circuit may be formed by the inherent distributed inductance and inherent distributed capacitance of the conducing elements of the antenna 25, in which case the antenna is designed and laid out in a manner that results in the appropriate chosen L and C values. Furthermore, the matching network 30 may be chosen so as to maximize the output of the charge pump 35 using a trial and error (“annealing”) empirical approach in which various sets of inductor and capacitor values are used as matching elements in the matching network 30, and the resulting output of the charge pump 35 is measured for each combination, and the combination that produces the maximum output is chosen.

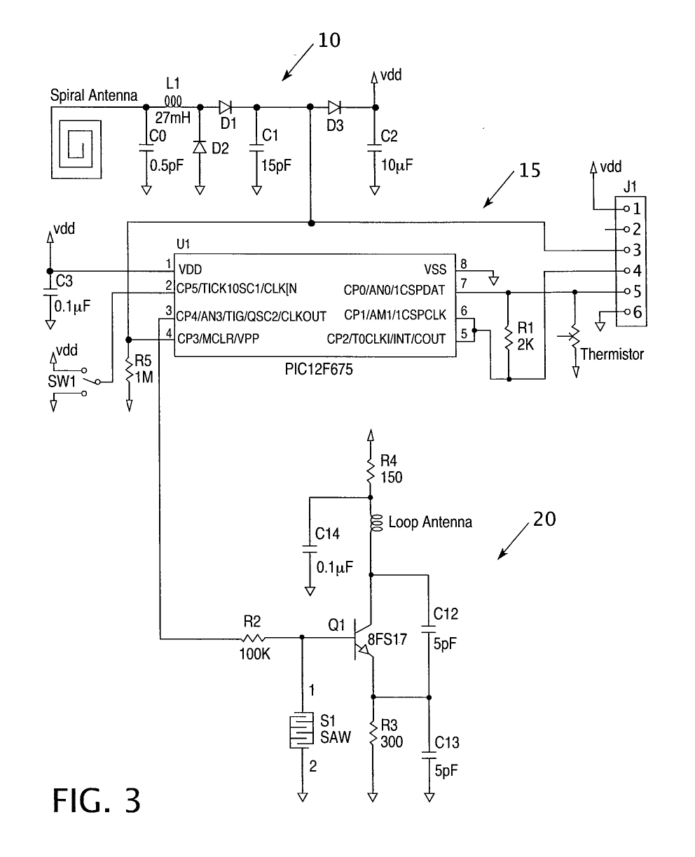

Referring again to FIG. 1, the on-board electronic circuitry 15 may include, for example, a processing unit, such as, without limitation, a microprocessor, a microcontroller or a PIC processor, additional logic circuitry, and a sensing circuit for sensing or measuring a particular parameter (such as temperature, in which case a thermistor may be included in the sensing circuit). As described above, these components are powered by the DC voltage output by the energy harvesting circuitry (e.g., the DC voltage output by the charge pump 35 shown in FIG. 2). In addition, the transmitter circuitry 20 includes an RF transmitter, which may be formed from discrete components or provided as a single IC chip, and a transmitting antenna. As described above, the transmitter circuitry 20 is also powered by the DC voltage output by the energy harvesting circuitry 10 and is structured to transmit an RF information signal at a frequency that is different from the frequency range of the RF energy received by the energy harvesting circuitry 10 based on information generated by the on-board electronic circuitry 15. For example, the transmitter circuitry 20 may transmit an RF signal that represents a temperature as measured by a thermistor provided as part of the on-board electronic circuitry 15. FIG. 3 is a circuit diagram of one particular embodiment of a WAD 5 that employs a thermistor as described above in which the energy harvesting circuitry 10, the on-board electronic circuitry 15, and the transmitter circuitry 20 are labeled.

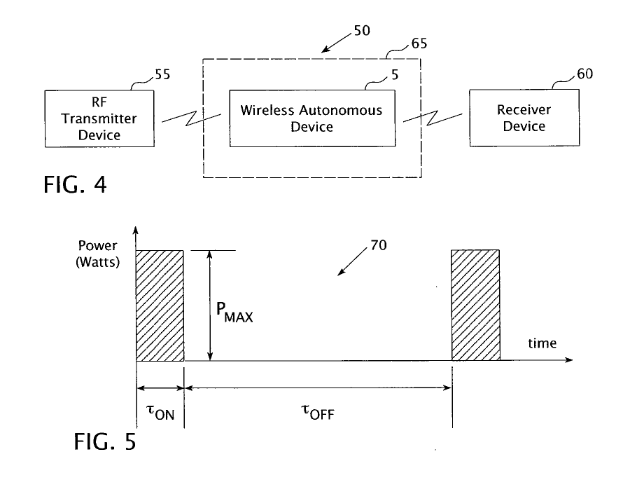

FIG. 4 is a schematic illustration of a WAD system 50 in which a plurality of WADs 5, such as in the form of RFID tags, may be employed. For convenience, only a single WAD 5 is shown in FIG. 4, but it should be understood that this is for illustrative purposes and that multiple WADs 5 are contemplated. As seen in FIG. 4, the WAD system 5 includes an RF transmitter device 55 for generating and transmitting RF energy of a particular frequency range powering the WADs 5 as described herein and a receiver device 60 (including suitable processing electronics) for receiving and processing the RF information signals that are generated and transmitted by the WADs 5 as described herein. The RF transmitter device 55 and the receiver device 60 may be located remotely from one another or may be co-located (in which case they may, although not necessarily, be included within the same apparatus such as an RFID interrogator). In addition, the WAD system 50 includes a defined device region 65 in which the WADs 5 are intended/designed to be able operate properly (i.e., receive power and transmit information as described herein). Outside of the defined device region 65, it is likely that a WAD 5 will not properly function due to an inability to receive power from the RF transmitter device 55, an inability to successfully transmit information to the receiver device 60, or both.

FIG. 5 is a schematic illustration of an RF transmitting profile 70 that, according to an aspect of the invention, may be transmitted by an RF source, such as the RF transmitting device 55 shown in FIG. 4, to provide power to a WAD 5 as shown in FIG. 1. As seen in FIG. 5, the RF transmitting profile 70 is a repeating, periodic pulsed profile wherein RF energy of a particular RF frequency range is transmitted during a time period τ_{ON} and wherein no RF energy is transmitted during a time period τ_{OFF}. In this sense, the RF transmitting profile 70 may be said to be an amplitude modulated (AM) profile wherein the carrier frequency is modulated in an ON/OFF fashion.

Furthermore, as is known in the art, the Federal Communications Commission (FCC) regulates the amount of energy/power that can be transmitted in a given amount of time in terms of what is known as effective average power or effective isotopic radiated power. Essentially, the regulations state that over a given time period, T_{AVG-REG}, no more than a specified average power, P_{AVG-REG}, may be transmitted by an RF source. In addition, the FCC also, in many instances, regulates the maximum power, P_{MAX-REG}, that can be transmitted at any time during T_{AVG-REG}. Thus, according to an aspect of the present invention, an optimum profile 70 for energy harvesting purposes is chosen in the following manner. First, τ_{ON}+τ_{OFF} is set equal to T_{AVG-REG}. It is then known that P_{AVG-REG}·(τ_{ON}+τ_{OFF}) equals some energy value E. It is also known that it is desired that τ_{ON}·P_{MAX}=E, where P_{MAX} is the power level that is to be transmitted during τ_{ON} and is set to either P_{MAX-REG} in situations where the P_{MAX-REG} regulations apply or, in the event that the P_{MAX-REG} regulations do not apply, to the maximum power that is practically possible in the given situation/application (e.g., as dictated by the RF source being used and/or the environment in which the RF source is being implemented). Thus, since P_{MAX} and E are known, one can solve for τ_{ON}. As will be appreciated, this will result in a specific RF transmitting profile 70 wherein the maximum power and voltage level are transmitted by the RF source for the maximum limited time that still allows the RF transmitting profile 70 to satisfy the effective average power regulations. From an energy harvesting standpoint, when the maximum power and voltage level are transmitted, the maximum energy can be harvested.

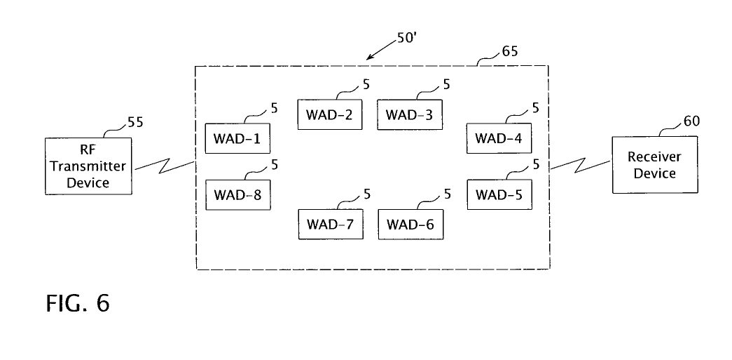

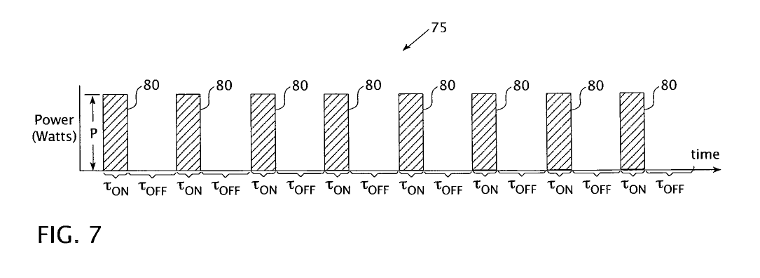

According to a further aspect of the present invention, a pulsed RF transmitting profile (having a form similar to the RF transmitting profile 70 shown in FIG. 5) that is used to provide power to one or more WADs 5 as described herein may also be used to simultaneously communicate information to the WADs 5. For example, in one particular embodiment of the system 50, shown in FIG. 6 and labeled 50′, a number of WADs 5 are provided in the defined device region 65 and each device is numbered consecutively beginning at 1. For illustrative purposes, eight WADs 5 are shown (numbered 1 though 8), although it will be understood that the number of WADs could be smaller or larger. In addition, each of the WADs 5 possesses, measures and/or collects certain information that is to be transmitted to the receiver device 60 based on a request/command received from the RF transmitter device 55. For example, each WAD 5 may measure one or more parameters, such as, without limitation, temperature, humidity or strain, which is/are to be transmitted to the receiver device 60. As will be appreciated, because there are multiple WADs 5, there needs to be some mechanism to cause the WADs 5 to transmit in a sequence so as to avoid data collision problems. According to one embodiment of the invention, that mechanism is provided in the form of information that is contained in the pulsed RF transmitting profile that is used to provide power to the WADs 5. In particular, in this embodiment, a pulsed RF transmitting profile 75 as shown in FIG. 7 is transmitted from the RF transmitter device 55 when it is desired to cause the WADs 5 to transmit their information. As seen in FIG. 7, the pulsed RF energy profile 75 is similar to the profile 70 and includes a number of power pulses 80 (ON states), each having a duration of τ_{ON} and a power level P (τ_{ON} and P may be, although not necessarily, chosen in the optimum manner described herein with reference to FIG. 5 and effective average power regulations), during which the RF transmitter device 55 is transmitting RF energy, followed by a period having a duration of τ_{OFF}, during which no energy is transmitted (OFF states). Specifically, the number of power pulses 80 is equal to the number of WADs 5 provided in the system 50′ (which in the example shown is eight). In addition, a portion of the on-board electronic circuitry 15 (e.g., a processing unit provided as a part thereof) of each WAD 5 is able to sense the trailing edge of each power pulse 80 included within the pulsed RF transmitting profile 75 by sensing that the associated energy harvesting circuitry 10 in the WAD 5 is outputting a reduced DC voltage. The on-board electronic circuitry 15 is also able to count each of these events (an interrupt). Moreover, as noted above, each WAD 5 is assigned a number from one to eight, and the on-board electronic circuitry 15 of each WAD 5 is programmed to cause the transmitter circuitry 20 thereof to transmit its information (e.g., measured temperature) when its counter reaches its assigned number. Thus, the WAD 5 labeled 1 in FIG. 6 will transmit on the trailing edge of the first power pulse 80, the WAD 5 labeled 2 in FIG. 6 will transmit on the trailing edge of the second power pulse 80, the WAD 5 labeled 3 in FIG. 6 will transmit on the trailing edge of the third power pulse 80, and so on. As a result, the transmission of data is synchronized based on information included in the pulsed RF transmitting profile 75 and data collisions are avoided. In other words, the ON/OFF modulation of the pulsed RF transmitting profile 75 is used as a means to communicate between the RF transmitter device 55 and the WADs 5. That same pulsed RF transmitting profile 75 also simultaneously provides the power, through energy harvesting as described herein, to power each of the WADs 5.

FIG. 8 is a schematic illustration of a pulsed RF transmitting profile 85 according to a further embodiment of the invention that may be used to provide power to one or more WADs 5 as described herein while simultaneously communicating information to the WADs 5. As seen in FIG. 8, the pulsed RF transmitting profile 85 includes a number of pulses during which an RF source, such as the RF transmitter device 55, is transmitting RF energy. In particular, the pulsed RF transmitting profile 85 includes a number of periodically spaced power/synchronization pulses 90 and a number of data pulses 95. The power/synchronization pulses 90 each have a duration equal to T₁ and the respective trailing and leading edges thereof are spaced by a time T₂. The data pulses 95, if present, are provided during the times T₂ in between the power/synchronization pulses 90. As described elsewhere herein, energy is harvested from each of the pulses (90 and 95) in order to provide power for the one or more WADs 5 in question. In addition, the on-board electronic circuitry 15 of each WAD 5 is programmed to recognize each of the power/synchronization pulses 90 (for example, by detecting a voltage output by the energy harvesting circuit 10 thereof having a duration of T₁, by detecting a voltage level output by the energy harvesting circuit 10 that would correspond to the power P of the power/synchronization pulses 90, or by some other suitable means) and determine whether a data pulse 95 is present in between each of the power/synchronization pulses 90. A scheme may then be established wherein if a data pulse 95 is present, that represents a logic 1, and if no data pulse 95 is present, that represents a logic 0. As will be appreciated, the scheme may be reversed such that the presence of a data pulse 95 in the T₂ time periods represents a logic 0 and the absence of a data pulse 95 in the T₂ time periods represents a logic 1. Thus, in the pulsed RF transmitting profile 85, the power/synchronization pulses 90 are used to synchronize the transmission of a number of bits of data to the WADs 5 while at the same time (along with the data pulses 95, if present) providing power to them. In a further alternative, the position of a particular signaling data pulse 95 in the time period T₂ may be used to signal alternative protocols. For example, if the information being communicated includes many logic 0s, the signaling data pulse 95 may be used to signal that a lack of a data pulse 95 in the T₂ time periods represents a logic 0. On the other hand, if the information being communicated includes many logic 1s, the signaling data pulse 95 may be used to signal that a lack of a data pulse 95 in the T₂ time periods represents a logic 1.

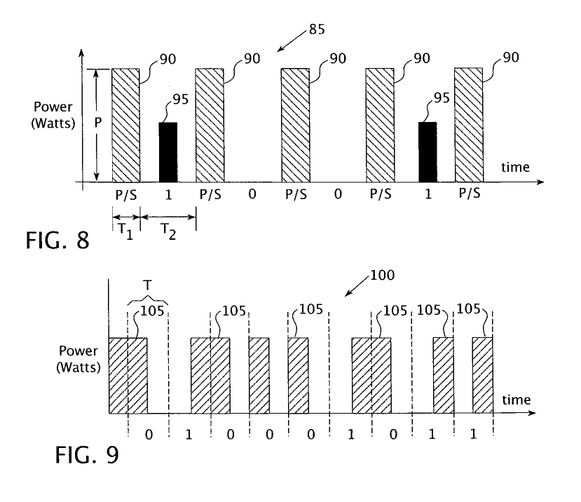

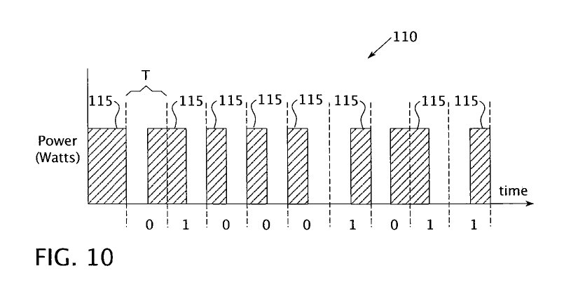

FIG. 9 is a schematic illustration of a pulsed RF transmitting profile 100 including pulses 105 according to a further embodiment of the invention that may be used to provide power by energy harvesting to one or more WADs 5 as described herein while simultaneously communicating information to the WADs 5 based on the state changes occurring in the RF transmitting profile 100. In the particular embodiment shown in FIG. 9, the RF transmitting profile 100 may be utilized to communicate information to one or more WADs 5 using a Manchester encoding scheme in which each bit of data is signified by at least one transition and wherein each bit is transmitted over a predefined time period, shown as time T in FIG. 9. As seen in FIG. 9, a high to low transition/state change within the time period T as a result of a pulse 105 represents a logic 0 and a low to high transition/state change within the time period T as a result of a pulse 105 represents a logic 1. This logic scheme can also be reversed to indicate 1,0 respectively. As also seen in FIG. 9, this will result in the widths of the pulses 105 being varied in order to convey the appropriate information via a state change. As is known, Manchester encoding is considered to be self-clocking, which means that accurate synchronization of a data stream is possible. In this embodiment, a portion of the on-board electronic circuitry 15 (e.g., a processing unit provided as a part thereof) of each WAD 5 is programmed to recognize the leading and trailing edge of each of the pulses 105 and decode the information therein based on the Manchester encoding scheme that is employed. As will be appreciated, other encoding schemes based on the recognition of changes of state and/or the widths of the pulses are possible, such as, without limitation, the differential Manchester encoding scheme shown in FIG. 10 and implemented by pulsed RF transmitting profile 110 including pulses 115. As is known, in differential Manchester encoding, one of the two bits, logic 0 or logic 1, is represented by no transition at the beginning of a pulse period (T) and a transition in either direction at the midpoint of a pulse period, and the other of the two bits is represented by a transition at the beginning of a pulse period (T) and a transition at the midpoint of the pulse period.

Moreover, in the various embodiments described herein, it is possible to continuously communicate from an RF source, such as the RF transmitter device 55 shown in FIG. 4, to a WAD 5 in order to send a message of arbitrary length from the RF source to the WAD 5. This may be accomplished so long as the pulses that are used in the particular pulsed RF transmitting profile are either close enough together or long enough to always keep the DC voltage that is generated by the energy harvesting circuitry 10 of the WAD 5 above the minimum operational voltage required by the WAD 5 (i.e., the voltage required by the on-board electronic circuitry 15 and the transmitter circuitry 20 thereof).

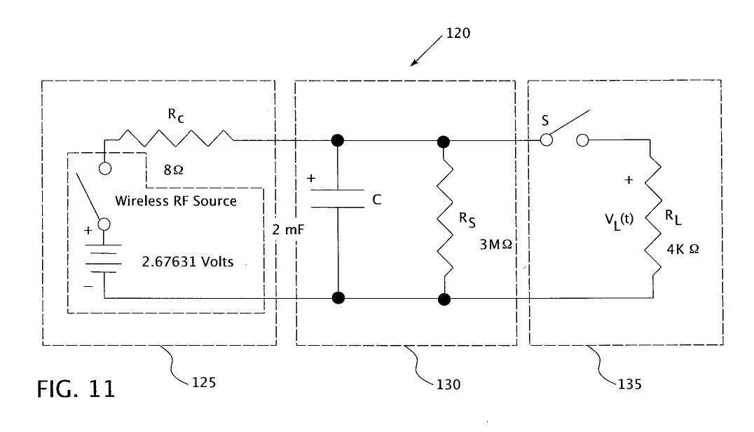

A further aspect of the present invention relates to a method of designing a WAD system 50 as shown in FIG. 4 and a WAD 5 for use therein that creates and utilizes a model equivalent circuit for the WAD 5 that is in the form of a lumped parameter RLC circuit with an energy source. As used herein, the term “lumped parameter RLC circuit with an energy source” shall mean an equivalent circuit that includes one or more energy sources and one of or any combination of two or more of: (i) one or more resistors that represent the resistance of various parts of the WAD 5, (ii) one or more inductors that represent the inductance of various parts of the WAD 5, and (iii) one or more capacitors that represent the capacitance of various parts of the WAD 5. FIG. 11 is a circuit diagram of one example of a lumped parameter RLC circuit with an energy source 120 that represents the WAD 5 shown in FIG. 1. The lumped parameter RLC circuit with an energy source 120 includes a first portion 125 which represents the energy harvesting circuit 10 of the WAD 5, a second portion 130 which represents the on-board electronic circuitry 15 of the WAD 5, and a third portion 135 which represents the RF transmitter circuitry 20 of the WAD 5. The first portion 125 includes a battery symbol to other power source which represents the DC voltage harvested by the energy harvesting circuitry 10 and a resistor R_{C} which represents the loss due to the components of the energy harvesting circuitry 10. The second portion 130 includes a capacitor C which represents the total capacitance of the on-board electronic circuitry 15 and a resistor R_{S} which represents the total resistance of the on-board electronic circuitry 15 when the WAD 5 is not transmitting. The third portion 135 includes a switch S to represent the transition between transmitting and non-transmitting conditions and a resistor R_{L} which represents the total resistance (transmitting load) of the RF transmitter circuitry 20 while transmitting.

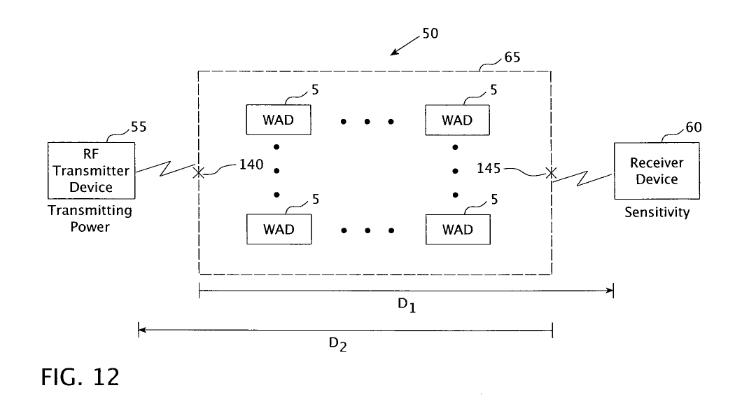

FIG. 12 is a schematic diagram of the WAD system 50 (FIG. 4) which illustrates certain parameters relating to the WAD system 50 and the WADs 5 to be used therein that are typically considered by a designer when designing the WAD system 50 and the WADs 5. With respect to the RF transmitter device 55, those parameters include, without limitation, the placement and transmitting power thereof, and with respect to the receiver device 60, those parameters include, without limitation, the placement and sensitivity thereof. As noted elsewhere herein, the RF transmitter device 55 and the receiver device 60 may or may not be co-located. In addition, as seen in FIG. 12, point 140 within the defined device region 65 represents the furthest distance D₁ that a WAD 5 will be from the receiver device 60. Knowing the distance D₁ and the sensitivity of the receiver device 60, a designer can determine the minimum power with which the WADs 5 must be able to transmit to enable them to properly function at the point 140 (which is a worst case scenario), i.e., to enable them to be able to transmit their information to the receiver device 60. This is a design parameter of the WADs 5, and in particular a design parameter of the transmitter circuitry 20 thereof. Point 145 within the defined device region 65 represents the furthest distance D₂ that a WAD 5 will be from the RF transmitter device 55. Knowing the distance D₂, a designer can determine the minimum power with which the RF transmitter device 55 must transmit to be able to provide power and/or information as described herein to WADs 5 at the point 145 (which is a worst case scenario which, if satisfied will allow all other WADs 5 positioned in the defined device region 65 to be powered and receive information).

In designing the parameters and/or components of the WAD system 50 and the WADs 5 to be used therein to provide a WAD system 50 that operates properly (i.e., all WADs 5 can function within the defined device region 65), it is advantageous to a designer to use a model equivalent circuit for the WAD 5 to made design decisions. Thus, according to an aspect of the present invention, a designer is able to create a model equivalent circuit for the WAD 5 that is in the form of a lumped parameter RLC circuit with an energy source, and use the model equivalent circuit for the WAD 5 that is in the form of a lumped parameter RLC circuit with an energy source to: (i) design parameters of the WAD system 50 (for example, and without limitation, the transmitting power of the RF transmitter device 55, the sensitivity of the receiver device 60, and/or the distances D₁ and D₂), and/or (ii) design the actual components of the WADs 5 that are to be used (for example, aspects of the energy harvesting circuitry 10, the on-board electronic circuitry 15 and/or the transmitter circuitry 20). For example, a designer could design the components of the WAD 5 (and therefore fix them), and use the model equivalent circuit for the WAD 5 that is in the form of a lumped parameter RLC circuit with an energy source (with fixed values) to design parameters of the WAD system 50. Alternatively, a designer could fix the parameters of the WAD system 50 and use the model equivalent circuit for the WAD 5 that is in the form of a lumped parameter RLC circuit with an energy source to design the actual components of the WADs 5 that are to be used. As still a further alternative, both the parameters of the WAD system 50 and the components of the WADs 5 that are to be used can be varied and designed using the model equivalent circuit for the WAD 5 that is in the form of a lumped parameter RLC circuit with an energy source. The lumped parameter RLC circuit with an energy source 120 shown in FIG. 11 is one example that may be used, but it should be understood that other lumped parameter RLC circuits with an energy source may also be used.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method of powering a wireless autonomous device, comprising:
providing said wireless autonomous device, said wireless autonomous device having energy harvesting circuitry, on-board electronic circuitry, and RF transmitter circuitry;
generating an RF transmitting profile, said RF transmitting profile including a plurality of pulses each having RF energy of a first RF frequency range, wherein each of said pulses is provided during a respective on period of said RF transmitting profile and wherein each adjacent pair of said pulses is separated by a respective off period of said RF transmitting profile, each said off period not including any RF energy;
transmitting said RF transmitting profile to said wireless autonomous device;
receiving said RF transmitting profile in said energy harvesting circuitry, said energy harvesting circuitry generating DC energy from the pulses included in said RF transmitting profile; and
using said DC energy to power said on-board electronic circuitry and said RF transmitter circuitry to enable said RF transmitter circuitry to transmit an RF information signal to a receiver device, said RF information signal having a second RF frequency range different than said first RF frequency range.

2. The method according to claim 1, wherein said step of generating an RF transmitting profile comprises generating an RF transmitting profile wherein each of said on periods has a duration τ_{ON} and wherein each of said off periods has a duration τ_{OFF.}

3. The method according to claim 2, wherein an effective average power regulation establishes a regulated maximum power and a regulated average power permitted during a regulation time period, said regulation time period being equal to the sum of the duration τ_{ON} and the duration τ_{OFF}, and wherein a power of each of said pulses is equal to or less than said regulated maximum power and an average power in said RF transmitting profile over each adjacent pair of on periods and off periods is equal to or less than said regulated average power.

4. The method according to claim 3, wherein the power of each of said pulses is equal to said regulated maximum power.

5. The method according to claim 4, wherein the average power over each adjacent pair of on periods and off periods is equal to said regulated average power.

6. The method according to claim 1, further comprising providing a plurality of other wireless autonomous devices in a wireless autonomous device system, each of said other wireless autonomous devices receiving and being powered by said RF transmitting profile, wherein each of said other wireless autonomous devices is adapted to transmit a respective other RF information signal to said receiver device, and wherein said RF transmitting profile is used to synchronize the timing of the transmission of said RF information signal and each of said other RF information signals to avoid collisions among said RF information signal and each of said other RF information signals.

7. The method according to claim 1, further comprising providing a plurality of other wireless autonomous devices in a wireless autonomous device system, each of said other wireless autonomous devices receiving and being powered by said RF transmitting profile, wherein each of said other wireless autonomous devices and said wireless autonomous device is assigned one of a plurality of unique identification numbers, wherein said wireless autonomous device is adapted to transmit said RF information signal to said receiver device when a number of the pulses of said RF transmitting profile received by said wireless autonomous device is equal to the identification number assigned thereto, and wherein each of said other wireless autonomous devices is adapted to transmit a respective other RF information signal to said receiver device when a number of the pulses of said RF transmitting profile received by each respective one of said other wireless autonomous devices is equal to the identification number assigned thereto.

8. The method according to claim 1 , wherein said step of generating an RF transmitting profile comprises generating the RF transmitting profile in a manner wherein the RF transmitting profile includes information intended for said wireless autonomous device, wherein said step of transmitting said RF transmitting profile to said wireless autonomous device further comprises communicating said information to said wireless autonomous device as part of said RF transmitting profile, and wherein said method further comprises obtaining said information from said RF transmitting profile in said wireless autonomous device.

9. The method according to claim 8, wherein said pulses of said RF transmitting profile include a plurality of synchronizing pulses and a plurality of data pulses, each adjacent pair of said synchronizing pulses being separated by a respective data region, wherein each data region either: (i) includes one of said data pulses or (ii) no data pulse, and wherein each data region having one of said data pulses represents a first logic value and each data region having no data pulse represents a second logic value, said information being represented by said data regions.

10. The method according to claim 8, wherein said pulses of said RF transmitting profile represent a plurality of state changes, wherein said information included in said RF transmitting profile is represented by a plurality of bits of data, each bit of data being signified by at least one of said state changes.

11. The method according to claim 10, wherein said state changes are arranged based on a Manchester encoding scheme.

12. The method according to claim 10, wherein said state changes are arranged based on a differential Manchester encoding scheme.

13. The method according to claim 8, wherein each of said pulses of said RF transmitting profile has a respective width, and wherein said information included in said RF transmitting profile is represented by varying said widths.

14. The method according to claim 1, wherein said step of using said DC energy to power said on-board electronic circuitry and said RF transmitter circuitry to enable said RF transmitter circuitry to transmit an RF information signal to a receiver device includes using said DC energy to power said on-board electronic circuitry to enable said on-board electronic circuitry to do one or both of: (i) generate data included in said RF information signal, and (ii) obtain data included in said RF information signal.

15. A wireless autonomous device system, comprising:
an RF transmitter device, said RF transmitter device being structured to: (i) generate an RF transmitting profile, said RF transmitting profile including a plurality of pulses each having RF energy of a first RF frequency range, wherein each of said pulses is provided during a respective on period of said RF transmitting profile and wherein each adjacent pair of said pulses is separated by a respective off period of said RF transmitting profile, each said off period not including any RF energy, and (ii) transmit said RF transmitting profile;
a receiver device; and
a plurality of wireless autonomous devices, each of said wireless autonomous devices having respective energy harvesting circuitry, on-board electronic circuitry, and RF transmitter circuitry, wherein the respective energy harvesting circuitry is structured to receive said RF transmitting profile and generate respective DC energy from the pulses included in said RF transmitting profile, and wherein each of said wireless autonomous devices is structured to using the respective DC energy generated by its energy harvesting circuitry to power its on-board electronic circuitry and its RF transmitter circuitry to enable its RF transmitter circuitry to transmit a respective RF information signal to a receiver device, each said respective RF information signal having a second RF frequency range different than said first RF frequency range.

16. The system according to claim 15, wherein said RF transmitter device and said receiver device are co-located.

17. The system according to claim 16, wherein said RF transmitter device and said receiver device are included within the same apparatus.

18. The system according to claim 15, wherein said RF transmitter device and said receiver device are not co-located.

19. The system according to claim 15, wherein each of said on periods has a duration τ_{ON} and wherein each of said off periods has a duration τ_{OFF.}

20. The system according to claim 19, wherein an effective average power regulation establishes a regulated maximum power and a regulated average power permitted during a regulation time period, said regulation time period being equal to the sum of the duration τ_{ON} and the duration τ_{OFF}, and wherein a power of each of said pulses is equal to or less than said regulated maximum power and an average power in said RF transmitting profile over each adjacent pair of on periods and off periods is equal to or less than said regulated average power.

21. The system according to claim 20, wherein the power of each of said pulses is equal to said regulated maximum power.

22. The system according to claim 21, wherein the average power over each adjacent pair of on periods and off periods is equal to said regulated average power.

23. The system according to claim 15, wherein said RF transmitting profile is used to synchronize the timing of the transmission of each said respective RF information signal to avoid collisions among said respective RF information signals.

24. The system according to claim 15, wherein each of said wireless autonomous devices is assigned one of a plurality of unique identification numbers, and wherein each of said wireless autonomous devices is adapted to transmit its respective RF information signal to said receiver device when a number of the pulses of said RF transmitting profile received by each respective one of said wireless autonomous devices is equal to the identification number assigned thereto.

25. The system according to claim 15, wherein said RF transmitting profile includes information intended for one or more of said wireless autonomous devices, wherein said information is communicated to said one or more of said wireless autonomous devices as part of said RF transmitting profile, and wherein said one or more of said wireless autonomous devices are structured to obtain said information from said RF transmitting profile.

26. The system according to claim 25, wherein said pulses of said RF transmitting profile include a plurality of synchronizing pulses and a plurality of data pulses, each adjacent pair of said synchronizing pulses being separated by a respective data region, wherein each data region either: (i) includes one of said data pulses or (ii) no data pulse, and wherein each data region having one of said data pulses represents a first logic value and each data region having no data pulse represents a second logic value, said information being represented by said data regions.

27. The system according to claim 25, wherein said pulses of said RF transmitting profile represent a plurality of state changes, wherein said information included in said RF transmitting profile is represented by a plurality of bits of data, each bit of data being signified by at least one of said state changes.

28. The system according to claim 27, wherein said state changes are arranged based on a Manchester encoding scheme.

29. The system according to claim 27, wherein said state changes are arranged based on a differential Manchester encoding scheme.

30. The system according to claim 25, wherein each of said pulses of said RF transmitting profile has a respective width, and wherein said information included in said RF transmitting profile is represented by varying said widths.

31. A method of designing a wireless autonomous device system having an RF transmitter device and a receiver device, comprising:
creating an equivalent circuit for a wireless autonomous device to be used in said wireless autonomous device system, said wireless autonomous device including energy harvesting circuitry, on-board electronic circuitry, and RF transmitter circuitry, said energy harvesting circuitry generating DC energy from RF energy received from said RF transmitter device, said DC energy being used to power said on-board electronic circuitry and said RF transmitter circuitry to enable said RF transmitter circuitry to transmit an RF information signal to said receiver device, said equivalent circuit being in the form of a lumped parameter RLC circuit with an energy source;
using the equivalent circuit to do one or both of: (i) design one or more selected parameters of the wireless autonomous device system, and (ii) design one or more selected portions of said wireless autonomous device to be used in said wireless autonomous device system.

32. The method according to claim 31, wherein said one or more selected portions of said wireless autonomous device to be used in said wireless autonomous device system include one or more of said energy harvesting circuitry, said on-board electronic circuitry, and said RF transmitter circuitry.

33. The method according to claim 31, wherein said wireless autonomous device system further includes a defined region in which said wireless autonomous device is to operate, wherein said one or more selected parameters of the wireless autonomous device system include one or more of a transmitting power of said RF transmitter device, a sensitivity of said receiver device, a first distance between said receiver device and a first point in said defined region that will be furthest away from said receiver device, and a second distance between said RF transmitter device and a second point in said defined region that will be furthest away from said RF transmitter device.

34. The method according to claim 31, wherein said RF transmitter device and said receiver device are co-located.

35. The method according to claim 31, wherein said RF transmitter device and said receiver device are not co-located.

36. The method according to claim 31, wherein said RF energy has a first RF frequency range and said RF information signal has a second RF frequency range.

37. The method according to claim 31, wherein said equivalent circuit includes a first portion including a power source which represents the DC energy harvested by the energy harvesting circuitry and a first resistor which represents a loss due to the energy harvesting circuitry, a second portion including a capacitor which represents a total capacitance of the on-board electronic circuitry and a second resistor which represents a total resistance of the on-board electronic circuitry when the RF transmitter circuitry is not transmitting, and third portion including a switch S and a third resistor which represents a total resistance of the RF transmitter circuitry while transmitting.
